(19) United States
(12) Patent Application Publication
(10) Pub. No.: US 2008/0264999 A1
(43) Pub. Date: Oct. 30, 2008

(54) Magazine for receiving nails of different lengths

(75) Inventor: Yi-Kuan Lee, Ta-Li City (TW)

Correspondence Address: CHARLES E. BAXLEY, ESQUIRE, 90 JOHN STREET, SUITE 309, NEW YORK, NY, 10038, US

(73) Assignee: Samson Power Tool Co., Ltd.

(21) Appl. No.: 11/796,394

(22) Filed: Apr. 27, 2007

(51) Int. Cl. B25C 1/00

(52) U.S. Cl. 227/109

(57) ABSTRACT

A magazine of a nailer includes two first ridges extending from two insides of the magazine and each first ridge has a groove defined in a bottom thereof so as to receive two guide members therein. A head of a longer nail is rested on the first ridges and the shank of the longer nail extends through a distance between the two first ridges. Two second ridges extend from the two insides of the magazine and are located beneath the first ridges. A head of a shorter nail is rested on the second ridges and the shank of the shorter nail extends through a distance between the two second ridges. The head of the shorter nail is guided by the guide members during being fed into the nose.

### FIELD OF THE INVENTION

The present invention relates to a magazine of a nailer nails of different lengths can be received in the same magazine.

### BACKGROUND OF THE INVENTION

A conventional nailer is shown in FIG. 1 and generally includes a barrel 1 with a nose 10 connected to an end thereof and a handle connected to the other end of the barrel 1. The nose 10 includes a passage 101 and the nails are pushed into the passage 101 one by one and are ejected out from the passage 101 to be nailed into an object which is not shown. A magazine 12 is connected to the nose 10 and includes a pushing member received therein so as to push the nails 11 received in the space 120 in the magazine 12. The pushing member pushes the nails 11 into the passage 101. As shown in FIG. 2, the space 120 is shaped to receive one specific size of the nails 11, if the user needs to use nails of different lengths, he or she has to prepare two different nailers because the conventional magazines and nailers are designed to shoot the nails with fixed length only. Besides, the conventional magazine is made by metal which is heavy and the users cannot operate the nailers for a longer time.

The present invention intends to provide an improved magazine for nailer and the magazine is made by non-metal material and includes two spaces for receive nails of different lengths respectively. The users need not to change another nailer for using the nails of different lengths.

### SUMMARY OF THE INVENTION

The present invention relates to a magazine of a nailer and the magazine includes two first ridges and two second ridges extending from two insides of the magazine. The two second ridges are located beneath the first ridges. Each first ridge has a groove defined in a bottom thereof and two guide members are engaged with the two respective grooves. Each guide member has a part thereof located in the magazine. A distance between the two respective parts of the two guide members is smaller than a head of a longer nail and larger than a shank of the longer nail. A distance between the two second ridges is smaller than a head 40′ of a second nail 4′ and larger than a shank 41′ of the second nail 4′. A third space is defined between the two second ridges and a second inner end of the magazine. The third space receives the shanks of the nails.

The primary object of the present invention is to provide a magazine with two pairs of ridges so as to respectively accommodate nails of different lengths.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a side view to show a conventional magazine for a nailer;

FIG. 2 is an end cross sectional view to show a nail is received in the conventional magazine;

FIG. 3 is a side view to show the magazine of the present invention, and

FIG. 4 is a perspective view, partly removed, of the magazine wherein a longer nail is received in the magazine, and

FIG. 5 is a perspective view, partly removed, of the magazine wherein a shorter nail is received in the magazine.

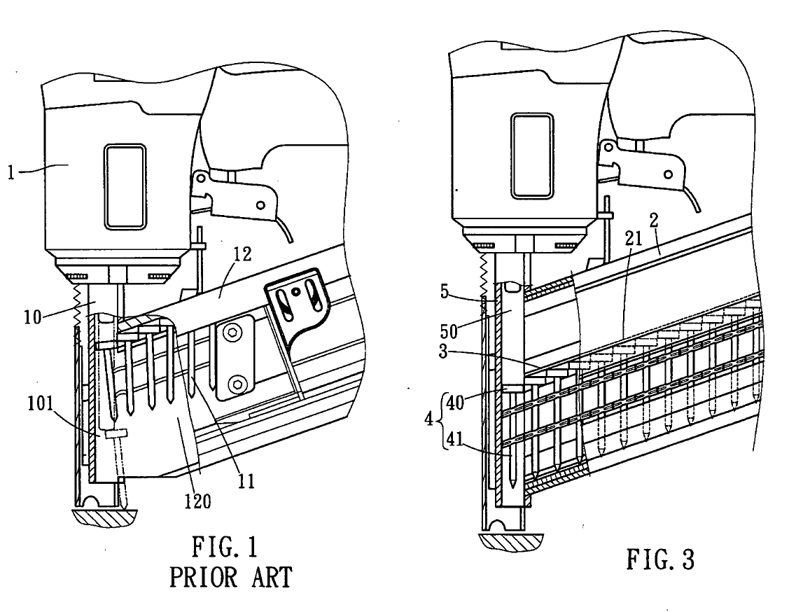

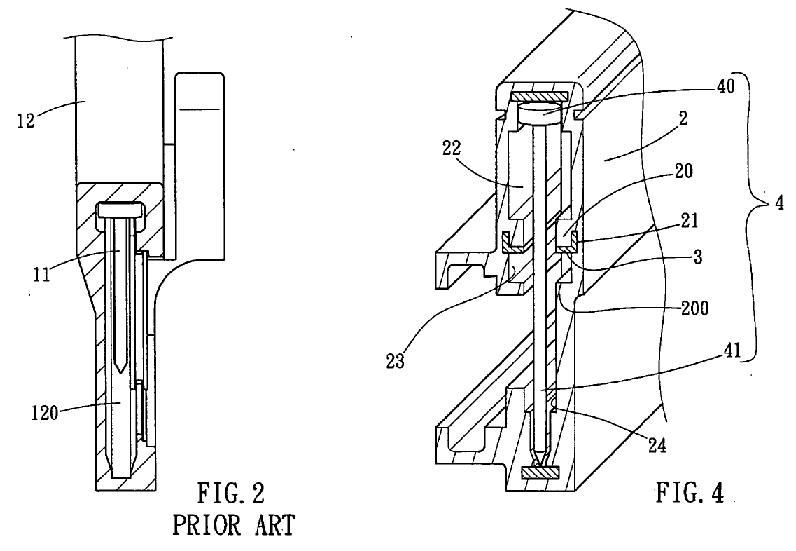

### DETAILED DESCRIPTION OF THE PREFERRED EMBODIMENT

Referring to FIGS. 3 and 4, a nailer comprises a barrel with a nose 5 connected to an end thereof and a passage 50 is defined in the nose 5, and a handle is connected to the other end of the barrel. A trigger unit is connected to the barrel and so as to introduce pressurized air into the barrel to eject nails out from the passage 50 of the nose 5. The magazine 2 of the present invention is made by non-metallic material and connected to the nose 5 so as to receive nails 4/4′ therein. A pushing member is biased by a spring and pushes the nails 4/4′ into the passage 50 of the nose 5 one by one.

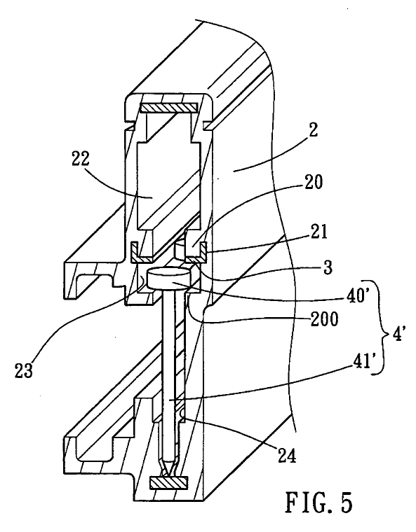

Two first ridges 20 extending from two insides of the magazine 2 and each first ridge 20 has a groove 21 defined in a bottom thereof. Two guide members 3 are made by highly durable material and engaged with the two respective grooves 21. A first space 22 is defined between a first inner end and the first ridges 20. Each guide member 3 has a part thereof, such as the underside of the guide member 3 in FIGS. 4 and 5, located in the magazine 2. A distance between the two respective parts of the two guide members 3 is smaller than a head 40 of a first nail 4 and larger than a shank 41 of the first nail 4.

Two second ridges 200 extend from the two insides of the magazine 2 and are located beneath the first ridges 20. A second space 23 is defined between the first ridges 20, the second ridges 200 and the two insides of the magazine 2. A distance between the two second ridges 200 is smaller than a head 40′ of a second nail 4′ and larger than a shank 41′ of the second nail 4′ as shown in FIG. 5. A third space 24 is defined between the two second ridges 200 and a second inner end of the magazine 2.

When using the longer nails 4, the head 40 of the longer nail 4 is rested on the top surfaces of the two first ridges 20 and the shank 41 of the longer nail 4 extends through the distance between the two first ridges 20 and located in the third space 24.

When using the shorter nails 5, the head 40′ of the longer nail 4′ is rested on the top surfaces of the two second ridges 200 and the shank 41′ of the longer nail 4′ extends through the distance between the two second ridges 200 and is located in the third space 24.

It is noted that when using the shorter nails 4′, the shorter nails 4′ are pushed by the pushing member and the heads 40′ are in contact with the guide members 3 so as to be fed into the passage 50 of the nose 5.

The magazine 2 of the present invention can accommodate longer nails 4 or shorter nails 4′ without changing to another magazine or nailer so that the user only carry one nail with the magazine 2 to use two different lengths of nails 4 and 4′ as needed.

While we have shown and described the embodiment in accordance with the present invention, it should be clear to those skilled in the art that further embodiments may be made without departing from the scope of the present invention.

What is claimed is:

1. A nailer comprising:
a barrel with a nose connected to an end thereof and a handle connected to the other end of the barrel;
a magazine connected to the nose and two first ridges extending from two insides of the magazine, each first ridge having a groove defined in a bottom thereof and two guide members engaged with the two respective grooves, a first space defined between a first inner end and the first ridges, each guide member having a part thereof located in the magazine, a distance between the two respective parts of the two guide members being smaller than a head of a first nail and larger than a shank of the first nail;
two second ridges extending from the two insides of the magazine and located beneath the first ridges, a second space defined between the first ridges, the second ridges and the two insides of the magazine, a distance between the two second ridges being smaller than a head of a second nail and larger than a shank of the second nail. and
a third space defined between the two second ridges and a second inner end of the magazine, the third space receiving the shanks of the nails.

2. The nailer as claimed in claim 1, wherein an underside of each of the guide members is located above the head of the second nail.

3. The nailer as claimed in claim 1, wherein the first nail is longer than the second nail.

4. The nailer as claimed in claim 1, wherein the magazine is made by non-metallic material.

5. The nailer as claimed in claim 1 wherein the guide members are made by durable material.
